(19) United States
(12) Patent Application Publication
(10) Pub. No.: US 2025/0380081 A1
(43) Pub. Date: Dec. 11, 2025

(54) WEARABLE ELECTRONIC DEVICE FOR CONTROLLING OUTPUT OF AUDIO SIGNAL, OPERATING METHOD THEREOF, AND STORAGE MEDIUM

(71) Applicant: SAMSUNG ELECTRONICS CO., LTD., Suwon-si (KR)

(72) Inventors: Hangil MOON, Suwon-si (KR); Brian HAN, Suwon-si (KR); Areum KO, Suwon-si (KR); Kyoungho BANG, Suwon-si (KR); Jooil SUNG, Suwon-si (KR); Jaemo YANG, Suwon-si (KR); Moa LEE, Suwon-si (KR); Jeonghwan CHOI, Suwon-si (KR)

(21) Appl. No.: 19/190,132

(22) Filed: Apr. 25, 2025

Related U.S. Application Data
(63) Continuation of application No. PCT/KR2025/004756, filed on Apr. 8, 2025.

(30) Foreign Application Priority Data
Jun. 11, 2024 (KR) 10-2024-0075932

(51) Int. Cl. H04R 1/10

(52) U.S. Cl. CPC H04R 1/1083; H04R 1/1016; H04R 2420/07

(57) ABSTRACT

A wearable electronic device may include at least first and second microphones disposed in a housing to face outside and inside a user's ear, a speaker, a processor, and memory storing instructions. The instructions, when executed, cause the wearable electronic device to output a first audio signal through the speaker, obtain a second audio signal by mixing the first audio signal and a noise signal through the at least one second microphone, based on a result of analyzing the second audio signal, adjust a gain of active noise canceling circuitry and a gain of at least one of transparency circuitry or sound source circuitry, and output, through the speaker, a third audio signal obtained by mixing an output of the gain-adjusted active noise canceling circuitry and an output of the gain-adjusted at least one of the transparency circuitry or the sound source circuitry.

### CROSS REFERENCE TO RELATED APPLICATIONS

This application is a continuation of International Application No. PCT/KR 2025/004756 filed on Apr. 8, 2025, designating the United States, in the Korean Intellectual Property Receiving Office, and claiming priority to Korean Patent Application No. 10-2024-0075932 filed on Jun. 11, 2024, the disclosures of which are all hereby incorporated by reference herein in their entireties.

### BACKGROUND

### Technical Field

An embodiment of the disclosure relates to a wearable electronic device for controlling the output of an audio signal, a method of operating the same, and a storage medium.

### Description of Related Art

The use of portable electronic devices such as smartphones, tablet PCs, and wearable devices has been increasing, and along with the rapid increase of the use of electronic devices, they are also being developed into a user-wearable form to improve portability and accessibility for users. An example of such electronic devices is an ear-wearable electronic device (e.g., earphones), and this electronic device may be powered by a rechargeable/dischargeable battery.

The wearable electronic device is an electronic device and/or additional device which has a miniaturized speaker unit built therein and is worn on the user's ear (e.g., external auditory canal) to directly emit sound generated from a speaker unit into the user's ear, allowing the user to hear sound even with a small output.

The above information is presented as related art only to assist with an understanding of the disclosure. No determination has been made, and no assertion is made, as to whether any of the above might be applicable as prior art with regard to the disclosure.

### SUMMARY

According to an embodiment, a wearable electronic device may include at least one first microphone disposed in a housing to face outside a user's ear, at least one second microphone disposed in the housing to face inside the user's ear, at least one speaker, at least one processor and memory storing instructions.

According to an embodiment, the instructions, when executed by the at least one processor, may cause the wearable electronic device configured to output a first audio signal through the at least one speaker.

According to an embodiment, the instructions, when executed by the at least one processor, may cause the wearable electronic device to obtain a second audio signal by mixing the first audio signal and a noise signal through the at least one second microphone among the at least one first microphone disposed in the housing to face outside a user's ear, and the at least one second microphone disposed in the housing to face inside the user's ear, when the wearable electronic device is worn by the user.

According to an embodiment, the instructions, when executed by the at least one processor, may cause the wearable electronic device to adjust a gain of active noise canceling circuitry and a gain of at least one of transparency circuitry or sound source circuitry based on a result of analyzing the second audio signal.

According to an embodiment, the instructions, when executed by the at least one processor, may cause the wearable electronic device to output, through the at least one speaker, a third audio signal obtained by mixing an output of the gain-adjusted active noise canceling circuitry and an output of the gain-adjusted at least one of the transparency circuitry or the sound source circuitry.

According to an embodiment, a method of controlling an output of an audio signal in the wearable electronic device may include outputting a first audio signal through the at least one speaker.

According to an embodiment, the method may include obtaining a second audio signal by mixing the first audio signal and a noise signal through the at least one second microphone among at least one first microphone disposed in the housing to face outside a user's ear and the at least one second microphone disposed in the housing to face inside the user's ear, when the wearable electronic device is worn by the user.

According to an embodiment, the method may include, based on a result of analyzing the second audio signal, adjusting a gain of the active noise canceling circuitry and a gain of at least one of the transparency circuitry and the sound source circuitry.

According to an embodiment, the method may include outputting, through the at least one speaker, a third audio signal obtained by mixing an output of the gain-adjusted active noise canceling circuitry and an output of the gain-adjusted at least one of the transparency circuitry or the sound source circuitry.

According to an embodiment, in computer-readable storage medium storing at least one instruction, the at least one instruction may cause the wearable electronic device to perform at least one operation, when executed by the at least one processor of the wearable electronic device. The at least one operation may include outputting a first audio signal through the at least one speaker.

According to an embodiment, the at least one operation may include obtaining a second audio signal by mixing the first audio signal and a noise signal through the at least one second microphone among the at least one first microphone disposed in the housing to face outside a user's ear and the at least one second microphone disposed in the housing to face inside the user's ear, when the wearable electronic device is worn by the user.

According to an embodiment, the at least one operation may include, based on a result of analyzing the second audio signal, adjusting a gain of the active noise canceling circuitry and a gain of at least one of the transparency circuitry or the sound source circuitry.

According to an embodiment, the at least one operation may include outputting, through the at least one speaker, a third audio signal obtained by mixing an output of the gain-adjusted active noise canceling circuitry and an output of the gain-adjusted at least one of the transparency circuitry or the sound source circuitry.

### BRIEF DESCRIPTION OF DRAWINGS

FIG. 1 is a block diagram illustrating an electronic device in a network environment according to an embodiment.

FIG. 2A is a diagram illustrating a connection relationship between a wearable electronic device and an electronic device according to an embodiment.

FIG. 2B is a block diagram illustrating a wearable electronic device 200 according to an embodiment.

FIG. 3 are perspective views illustrating a wearable electronic device according to an embodiment.

FIG. 4 is a diagram illustrating a wearable electronic device worn on a user's body according to an embodiment.

FIG. 5 is an internal block diagram illustrating a wearable electronic device for controlling the output of an audio signal according to an embodiment.

FIG. 6 are diagrams illustrating a combination of audio signals before being output through a speaker according to an embodiment.

FIG. 7 is a flowchart illustrating an operation of a wearable electronic device for controlling the output of an audio signal according to an embodiment.

FIG. 8 is a detailed flowchart illustrating an operation of controlling the output of an audio signal including a sound source in a wearable electronic device according to an embodiment.

FIG. 9 is a diagram illustrating an operation of analyzing an audio signal obtained through a microphone according to an embodiment.

FIG. 10 is a diagram illustrating a method of adjusting a gain based on setting information according to an embodiment.

In relation to the description of the drawings, the same or similar reference numerals may be used for the same or similar components.

### DETAILED DESCRIPTION

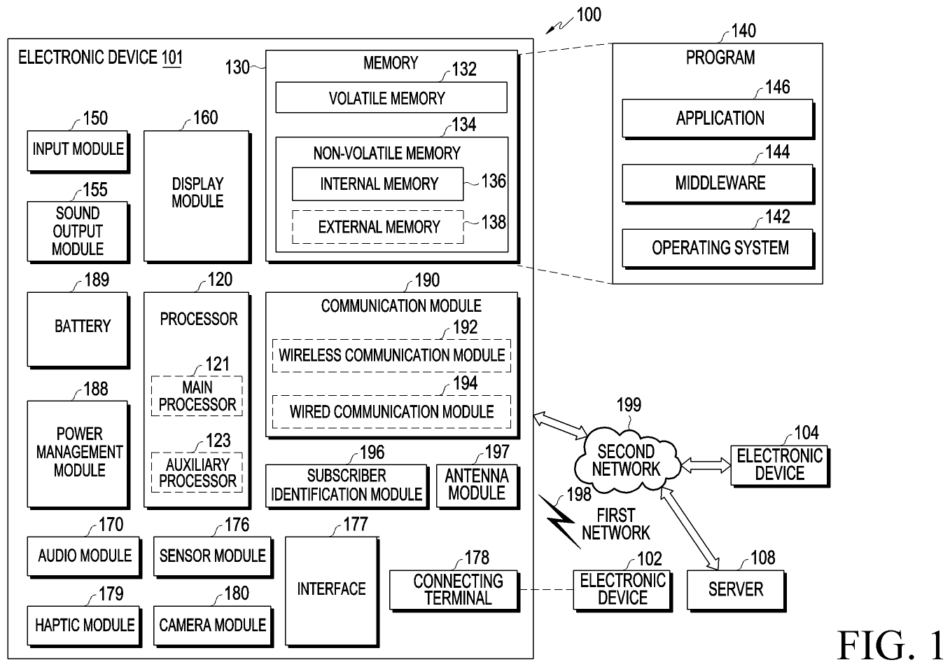

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IM SI)) stored in the subscriber identification module 196.

The wireless communication module 192 may support a 5G network, after a 4G network, and next-generation communication technology, e.g., new radio (NR) access technology. The NR access technology may support enhanced mobile broadband (eM BB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eM BB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a R FIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, the same reference numerals or no reference numerals may be assigned to components that may be easily understood from the preceding embodiments in the drawings, and their detailed descriptions may also be omitted. The electronic device 101 according to an embodiment of the disclosure may be implemented by selectively combining components of different embodiments, and a component of an embodiment may be replaced by a component of another embodiment. For example, it should be noted that the disclosure is not limited to a specific drawing or embodiment.

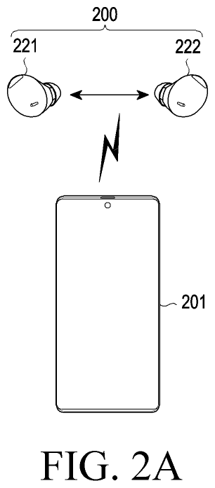

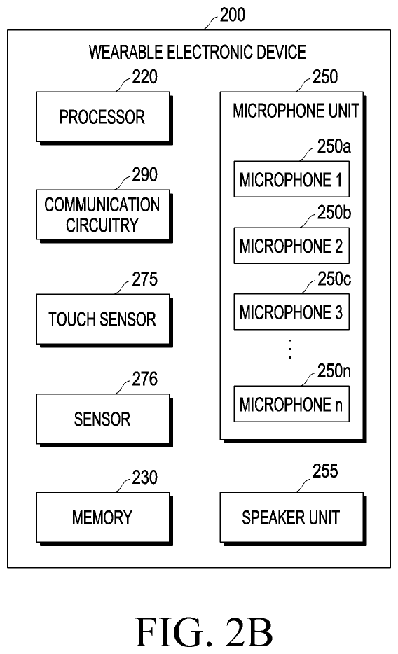

FIG. 2A is a diagram illustrating a connection relationship between a wearable electronic device 200 and an electronic device 201 according to an embodiment.

Referring to FIG. 2A, the wearable electronic device 200 and the electronic device 201 may be connected using a wireless communication network. The electronic device 201 may include components that are the same as or similar to at least some of the components and/or functions of the electronic device 101 illustrated in FIG. 1. For example, the wearable electronic device 200 may be connected to the electronic device 201 using a Bluetooth scheme, to which the wireless communication scheme is not limited.

Hereinbelow, the wearable electronic device 200 may be referred to as a first wearable electronic device 221, a second wearable electronic device 222, or the first and second wearable electronic devices 221 and 222. As such, the wearable electronic device 200 may be configured as a pair of devices (e.g., an earphone wearable on the right ear and an earphone wearable on the left ear), such as the first wearable electronic device 221 and the second wearable electronic device 222, and the pair of devices may include the same components. The wearable electronic device 200 may include, but is not limited to, wireless earphones, a headset, or earbuds. The wearable electronic device 200 may include various types of devices (e.g., hearing aids or a portable audio device) that receive an audio signal and output the received audio signal. The wearable electronic device 200 may be referred to as wireless earphones, earbuds, a true wireless stereo (TWS), or earsets.

The first wearable electronic device 221 and the second wearable electronic device 222 may be connected to each other using wireless communication. Although each of the first wearable electronic device 221 and the second wearable electronic device 222 may be connected to the electronic device 201 using a wireless communication network, either the first wearable electronic device 221 or the second wearable electronic device 222 may be connected to the electronic device 201.

According to an embodiment, the wearable electronic device 200 may receive audio data (or audio information) from the electronic device 201. The audio data may be a voice signal or a sound signal or may be some other type of signal, and may be a signal obtained by digitizing the voice signal or the sound signal. The wearable electronic device 200 may output a sound signal based on the received audio data.

The wearable electronic device 200 may perform a noise canceling (e.g., active noise canceling (ANC)) function through a microphone and a speaker to remove ambient noise. In addition, the wearable electronic device 200 may perform a transparency function and/or a personal sound amplification products (PSAP) function that outputs ambient sound received through the microphone. Accordingly, a user may hear the ambient sound even while wearing the wearable electronic device 200 on/in his or her ears.

The user may manually select to activate (or on)/deactivate (or off) a function such as the ANC function or the transparency function. For example, when the ANC function is activated or the transparency function is deactivated, the user may have difficulty hearing external sound. On the contrary, when the transparency function is activated while the wearable electronic device 200 is worn, ambient sound received by the microphone of the wearable electronic device 200 may be output in real time, allowing the user to hear external sound.

However, when the wearable electronic device 200 is worn without being tightly attached to the ear, external noise may enter through the gap between the ear and the wearable electronic device 200. Therefore, the user may hear sound output through the wearable electronic device 200 as well as external noise.

As such, the characteristics of sound heard by the user may vary based on various surrounding environments and/or wearing states. For example, increasing the gain of ANC filter circuitry may reduce external noise but cause howling, and thus, the volume of sound heard by the user may increase. Further, to improve a signal-to-noise ratio (SNR) during media playback, the volume level may be increased during media playback while decreasing the gain of the ANC filter circuitry. However, addition of external noise entering through the gap between the ear and the wearable electronic device 200 may increase the volume of sound actually heard by the user to a level that may damage hearing.

Therefore, when an audio signal is output through the wearable electronic device 200, it is necessary to control the output of the audio signal toward the user's inner ear according to various surrounding environments and/or wearing states.

In an embodiment, the disclosure provides a wearable electronic device for controlling the output of an audio signal, a method of operating the same, and a storage medium.

According to an embodiment, the output of an audio signal may be controlled by adjusting the gain of filter circuitry in response to the magnitude of the output of the audio signal output toward the user's inner ear, regardless of whether a function such as the ANC function or the transparency function is activated/deactivated. In this way, the wearable electronic device 200 may adaptively control the output of an audio signal in response to various surrounding environments and/or wearing states, thereby having the effect of adjusting the intensity of sound heard by the user and thus protecting hearing.

FIG. 2B is a block diagram illustrating the wearable electronic device 200 according to an embodiment.

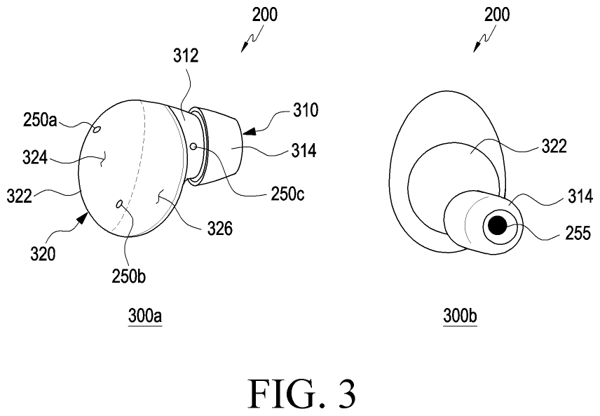

Referring to FIG. 2B, the wearable electronic device 200 may include a processor 220, memory 230, a microphone unit 250, and a speaker unit 255. According to an embodiment, the wearable electronic device 200 may further include communication circuitry 290, a touch sensor 275, and/or a sensor 276. As will be seen from FIG. 3, the wearable electronic device 200 may include a body and a plurality of (e.g., at least two) ear tips (e.g., an ear tip 314 of FIG. 3), and the component(s) described in FIG. 2B may be substantially accommodated in a housing 322 of FIG. 3.

According to an embodiment, the processor 220 may control at least one other component connected to the processor 220 by executing software (e.g., the program 140 of FIG. 1) and perform wireless communication with an electronic device (e.g., the electronic device 201 of FIG. 2A) using the communication circuitry 290 (e.g., the communication module 190 of FIG. 1). According to an embodiment, information about user settings set in the electronic device 201 may be received through the communication circuitry 290, and the processor 220 may control the wearable electronic device 200 (e.g., the speaker unit 255) based on the information received through the communication circuitry 290.

In an embodiment, the processor 220 may transmit information about a current operation state to the electronic device 201 through the communication circuitry 290, and the user may identify the operation state of the wearable electronic device 200 through the electronic device 201.

According to an embodiment, the speaker unit 255 may receive an electric signal from the processor 220, generate sound, and output the sound to the outside. For example, the speaker unit 255 may include at least one speaker (e.g., a speaker 255 of FIG. 3).

According to an embodiment, the microphone unit 250 may include a plurality of microphones 1 to n 250a, 250b, . . . , 250n. The microphone unit 250 or the wearable electronic device 200 may detect the direction of sound or detect external sound through the plurality of microphones 250a, 250b, . . . , 250n. The wearable electronic device 200 or the processor 220 may suppress or remove noise based on the external sound detected by the microphone unit 250. For example, the processor 220 may attenuate sound other than multimedia sound or ringtone output from the speaker unit 255, based on the external sound detected by the microphone unit 250. In a voice call mode, at least one of the plurality of microphones 250a, 250b, . . . , 250n may collect the user's voice. The wearable electronic device 200 or the processor 220 may improve call quality in the voice call mode by reinforcing the user's voice and suppressing external sound, using sound collected through the plurality of microphones 250a, 250b, . . . , 250n.

According to an embodiment, at least one first microphone (e.g., microphone 1 250a and microphone 2 250b) (e.g., external microphones 250a and 250b of FIG. 3) among the plurality of microphones 250a, 250b, . . . , 250n may include a sound-receiving microphone for an ambient sound listening function (e.g., the transparency function or ambient aware function) or the PSAP function. The at least one first microphone 250a and 250b may be disposed to detect sound directed toward the outside of the user, when the wearable electronic device 200 is worn by the user. The at least one first microphone 250a and 250b may be referred to as an external microphone. The at least one first microphone 250a and 250b may detect sound generated around the wearable electronic device 200, and the sound in the surrounding environment detected by the at least one first microphone 250a and 250b may be output from at least one speaker (e.g., the speaker 255 of FIG. 3).

According to an embodiment, at least one second microphone (e.g., microphone 3 250c) (e.g., an internal microphone 250c of FIG. 3) among the plurality of microphones 250a, 250b, . . . , 250n may be disposed such that the at least one speaker (e.g., the speaker 255 of FIG. 3) receives sound output to the ear cavity of the user. The at least one second microphone 250c may be referred to as an internal microphone, a feedback microphone, or an error microphone.

According to an embodiment, at least one sensor 276 (e.g., the sensor module 176 of FIG. 1) may generate an electric signal or data value corresponding to an internal operation state or external environmental state of the wearable electronic device 200. According to an embodiment, the sensor 276 may generate (output or detect) context information associated with the user.

According to an embodiment, the sensor 276 may periodically or continuously sense proximity information, motion information, or angle information using at least one of a proximity sensor, a grip sensor, an acceleration sensor, or a gyro sensor. For example, the proximity sensor may be an optical sensor or an ultrasonic sensor and in some cases, a capacitive touch sensor that detects proximity, when it touches the user's body, and may generate an electric signal or data value corresponding to the detected state. Sensing information through the at least one sensor may be collected through a sensor hub of the sensor 276 in a low-power state.

For example, the sensor 276 may detect whether the user is wearing the wearable electronic device 200, and generate context information related to a situation in which the user is running or driving. For example, the context information may include information about various types of surrounding sound environments related to the user wearing the wearable electronic device 200, such as vehicle sounds, siren sounds, highway noise, or construction site noise, to which the type of context information that may be sensed by the sensor 276 is not limited.

The processor 220 may identify a surrounding sound environment including a state of the user wearing the wearable electronic device 200 based on the context information sensed or detected by the sensor 276.

According to an embodiment, the touch sensor 275 may be a capacitive touch sensor or pressure-sensitive touch sensor for detecting a touch.

In an embodiment, the processor 220 may identify a wearing state of the wearable electronic device 200, using the at least one sensor 276, and activate at least one of the plurality of microphones 250a, 250b, . . . , 250n of the microphone unit 250 to receive a sound signal, based on the detection of wearing of the wearable electronic device 200.

In an embodiment, the processor 220 may receive audio data (e.g., download audio data or streaming audio data) from the electronic device 201 and store it in the memory 230. The processor 220 may reproduce audio data stored in the memory 230 and output it through the speaker unit 255. Further, the processor 220 may output an audio signal corresponding to a voice during a call.

In an embodiment, the processor 220 may collect an ambient sound signal through each of the at least one first microphone (e.g., microphone 1 250a and microphone 2 250b) among the plurality of microphones 250a, 250b, . . . , 250n to adjust the output of an audio signal when outputting the audio signal through the speaker unit 255, and may receive the output of the speaker unit 255 through the at least one second microphone (e.g., microphone 3 250c).

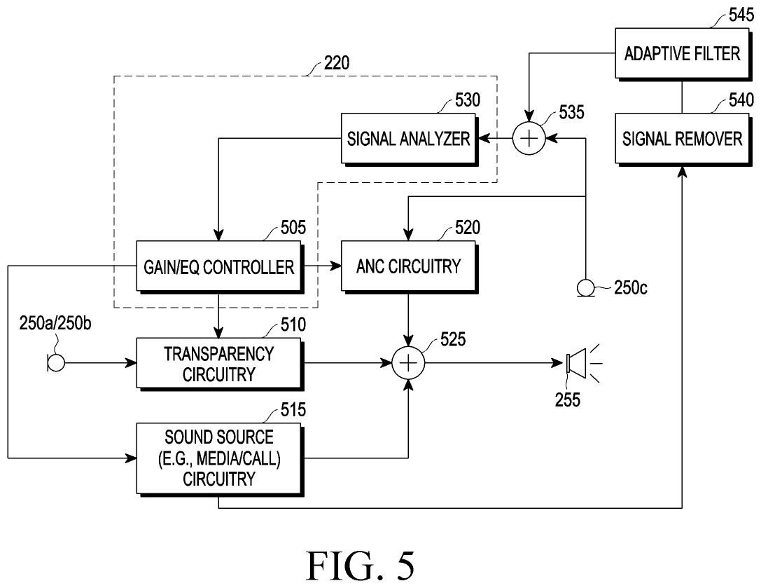

For example, when the wearable electronic device 200 is worn by the user, the at least one second microphone (e.g., microphone 3 250c) disposed in the housing to face inside the user's ear may receive a signal used to adjust (or determine) a gain of filter circuitry (e.g., transparency circuitry 510, sound source circuitry 515, or ANC circuitry 520 of FIG. 5).

The processor 220 may adjust an operation property of the speaker unit 255 based on the wearing being detected by the sensor 276 and a touch input for operation control by the touch sensor 275. The operation property of the speaker unit 255 may include a parameter for the filter circuitry, for example, at least one of a parameter related to an equalizer filter, a parameter related to an equalizer gain, a parameter related to acoustic echo cancellation (AEC), a parameter related to ANC, a parameter related to the transparency function, a parameter related to the PSAP function, and/or a parameter related to noise reduction.

In an embodiment, the processor 220 may adjust the gain of the filter circuitry based on a result of analyzing a signal received through the at least one second microphone (e.g., microphone 3 250c) disposed in the housing to face inside the user's ear. For example, the processor 220 may change settings for the gain of each of filter circuitries (e.g., the transparency circuitry 510, the sound source circuitry 515, and the ANC circuitry 520 of FIG. 5), which will be described in detail later in FIG. 5.

According to an embodiment, the memory 230 may store an operating system related to the operation of the wearable electronic device 200, and/or a program or at least one application supporting at least one user function executed through the wearable electronic device 200.

According to an embodiment, the memory 230 may store instructions, and the instructions may be configured to, when executed by the at least one processor 220, cause the wearable electronic device 200 to receive a signal corresponding to an audio signal through the at least one second microphone (e.g., microphone 3 250c) disposed in the housing to face inside the user's ear, when outputting the audio signal through the speaker unit 255. The signal received (or obtained) through the at least one second microphone may include the audio signal output through the speaker unit 255 as well as an ambient noise signal. Therefore, the audio signal obtained through the at least one second microphone may be a signal in which an output signal from the speaker unit 255 and a noise signal are mixed. The instructions may be configured to cause the wearable electronic device 200 to analyze the obtained audio signal and adjust a gain of the filter circuitry (e.g., the transparency circuitry 510, the sound source circuitry 515, or the ANC circuitry 520 of FIG. 5) based on a result of analyzing the audio signal. The instructions may be configured to cause the wearable electronic device 200 to output an audio signal obtained by mixing outputs of the gain-adjusted filter circuitries (e.g., the transparency circuitry 510, the sound source circuitry 515, and the ANC circuitry 520 of FIG. 5) through the speaker unit 255. As such, the influence of ambient noise on a voice may be reduced by adjusting the gain of each filter circuitry based on the result of analyzing the audio signal, thereby increasing voice clarity while preventing hearing damage.

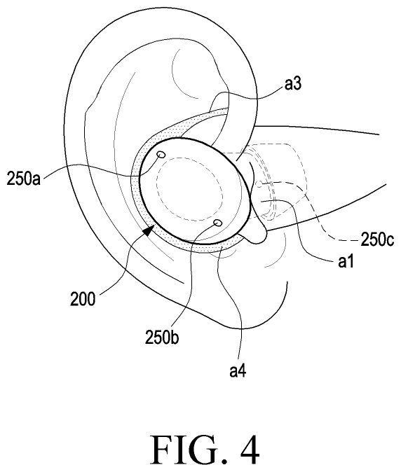

FIG. 3 are perspective views illustrating a wearable electronic device according to an embodiment, and FIG. 4 is a diagram illustrating a wearable electronic device worn on a user's body according to an embodiment.

According to an embodiment, the wearable electronic device 200 may be an audio device, and may be a device wearable on a user's body. For example, when it is wearable on the user's body (e.g., an ear), the wearable electronic device 200 may also be called an earphone, an ear piece, an ear bud, or an auditory device. When the wearable electronic device 200 is wireless earphones wearable on the user's body (e.g., the ears), the wearable electronic device 200 may include a pair of devices (e.g., an earphone wearable on the right ear and an earphone wearable on the left ear), and the pair of devices may include the same components. Without being limited to what has been described, the wearable electronic device 200 may be various types of wireless earphones.

According to an embodiment, the wearable electronic device 200 may include the housing (or body) 322, as illustrated in FIG. 3. For example, the housing 322 may include a part that is detachably mounted on a part of the user's body, and since its internal space may include the components described above with reference to FIG. 2, a redundant description is omitted. According to an embodiment, the wearable electronic device 200 may have various housing shapes depending on the body part on which the wearable electronic device 200 is worn (or detachably attached), and may further include various modules depending on the shape of the provided housing. Although along with the trend of convergence of digital devices, modifications are so diverse that they may not all be listed, components equivalent to the above-mentioned components may be further included in the wearable electronic device 200. Further, obviously, certain components of the above-mentioned components may be excluded or replaced with other components in the wearable electronic device 200 according to an embodiment, depending on the form in which the wearable electronic device 200 is provided. This will be easily understood by those skilled in the art.

Referring to 300a of FIG. 3, the wearable electronic device 200 may include a first part 310 inserted into the user's external auditory canal to transmit sound to the user, and a second part 320 mounted on a part of the user's ear. The foregoing description of the wearable electronic device 200 in FIGS. 2A and 2B may be applied to the wearable electronic device 200 of FIG. 3.

According to an embodiment, the first part 310 may extend from at least a portion of the second part 320. In an embodiment, the first part 310 may extend in a first direction from a portion of the second part 320 having a relatively large area in order to be closely inserted into the user's external auditory canal. At least a partial area (e.g., an extended portion 312) of the first part 310 extended from the second part 320 may have a width smaller than that of the second part 320. In an embodiment, the first part 310 may include the ear tip 314. The ear tip 314 may be disposed at or coupled to an end of the first part 310 facing in the first direction. For example, the ear tip 314 may be disposed at or coupled to an end of the extended portion 312 facing in the first direction. In an embodiment, the ear tip 314 may be formed of an elastic material.

300b of FIG. 3 is a rear view illustrating the wearable electronic device 200, in which the speaker 255 may be coupled to the ear tip 314 through one end of the housing 322. For example, the ear tip 314 may include a rubber material. When at least a portion of the first part 310 is inserted into the user's external auditory canal through the ear tip 314, the ear tip 314 may be in close contact with the user's external auditory canal.

Referring to FIGS. 3 and 4, the wearable electronic device 200 may be seated on a concha al. In an embodiment, the first part 310 may be inserted into the user's external auditory canal, and a lower area of the second part 320 may be seated on the user's concha al. At least a portion of a lateral (y-axis and/or z-axis direction) edge area of the second part 320 may be mounted to be surrounded by the user's antihelix a3 and/or antitragus a4. As the lateral edge area of the second part 320 is disposed to be surrounded by the portions a3 and a4 of the user's ear, the wearable electronic device 200 may be prevented from being detached from the user's ear.

The wearable electronic device 200 may include a plurality of microphones 250a, 250b, 250n. According to an embodiment, the plurality of microphones 250a, 250b, . . . , 250n may be arranged to collect external sound signals, while the wearable electronic device 200 is worn on a part of the user's body. For example, among the plurality of microphones 250a, 250b, . . . , 250n, microphone 1 250a and microphone 2 250b may be disposed in the second part 320, so that at least a portion of an acoustic hole is exposed to the outside with respect to the inner side of the ear, to enable the wearable electronic device 200 to collect an external sound signal while being worn on a part (e.g., an ear) of the user's body. In addition, one of microphone 1 250a and microphone 2 250b may be disposed such that at least a portion of the acoustic hole is exposed toward the inside of the outer ear canal, with respect to an opening in the auricle of the outer ear canal, or at least a portion thereof is in contact with the inner wall of the outer ear canal, to enable the wearable electronic device 200 to collect a signal transmitted to the inside of the outer ear canal, while being worn on the user's ear.

With the wearable electronic device 200 seated on the user's ear, the user may control the wearable electronic device 200 by touching at least a partial area of the wearable electronic device 200. The user may control an operation of the wearable electronic device 200 by touching a touch area 324 or 326.

In the foregoing and following descriptions of the disclosure, the wearable electronic device 200 may be defined as having various operation states, for convenience of description. For example, the operation states of the wearable electronic device 200 may include a call state, a content (or media) play state, a content play stop state, a next-content play state, and/or a previous-content play state. However, this is only an example, and it will be understood that various operation states may be implemented.

While the wearable electronic device 200 in the form of a kernel wearable on an ear has been described above with reference to FIGS. 3 and 4 as an example of a device wearable on a user's body, the disclosure may also be applied to open-type and headset-type devices.

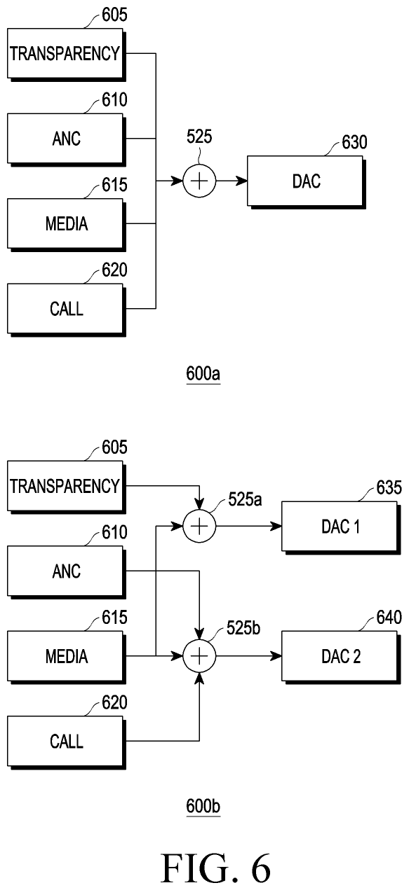

FIG. 5 is an internal block diagram illustrating a wearable electronic device for controlling the output of an audio signal according to an embodiment. FIG. 5 will be described with reference to FIG. 6. FIG. 6 are diagrams illustrating a combination of audio signals before being output through a speaker according to an embodiment.

Referring to FIG. 5, the wearable electronic device 200 may include the processor 220 (or a control circuit) (e.g., the processor 220 of FIG. 2B) for adjusting (or controlling) the gain of filter circuitry. The processor 220 may receive an output of the speaker 255 through at least one internal microphone 250c (e.g., microphone 3 250c in FIGS. 3 and 4) and may adjust the gain of the filter circuitry based on a result of analyzing the received signal. The processor 220 may output an audio signal with changed characteristics through the speaker 255 using the gain-adjusted filter circuitry.

In an embodiment, the filter circuitry may be a component that adjusts the intensity (or magnitude) of an output signal according to the characteristics of an input signal. The intensity of the output signal may be changed based on the gain of the filter circuitry. In an embodiment, the filter circuitry includes the transparency circuitry 510, the sound source circuitry 515, and/or the noise canceling circuitry 520, by way of example, to which the type of the filter circuitry is not limited. The sound source circuitry 515 may include a media source associated with media playback and/or a voice source associated with a call.

At least some of the components in FIG. 5 may be implemented in software, the components are distinguished logically, and any program, thread, or code that performs the same function may correspond to the components. For example, although the processor 220 (or the control circuit) is shown as including a signal analyzer 530 and a gain/EQ controller 505, this is only an example, and may represent the operation of the processor 220.

In an embodiment, the processor 220 may output a first audio signal through the speaker 255 in response to a media playback request or a call connection request. The processor 220 may receive a second audio signal corresponding to the first audio signal through the internal microphone 250c. Even if the first audio signal is output through the speaker 255, the output of the speaker 255 as well as a noise signal such as low-pitched sounds penetrating the wearable electronic device 200, external noise entering through an ear gap, and a voice entering through the Eustachian tube may be received through the internal microphone 250c. The processor 220 may obtain the second audio signal by mixing 535 the first audio signal and the noise signal.

For example, the signal analyzer 530 may convert the second audio signal into a time domain or a frequency domain, and may extract one or more features from the second audio signal in the time domain or the frequency domain. The signal analyzer 530 may determine the gain of each filter circuitry according to the extracted features. Further, the signal analyzer 530 may compare a sound pressure level (SPL) among the one or more features in the frequency domain with a threshold level. The signal analyzer 530 may extract features such as tonality, spectral centroid, and spectral flatness.

The signal analyzer 530 may classify a feature in an embedding space or the type of the second audio signal into a corresponding sound using a deep neural network (DNN) method. For example, the signal analyzer 530 may classify sounds such as a vehicle sound, a siren sound, and a male, female, or child voice by analyzing the second audio signal.

The gain/EQ controller 505 may adjust the gain of the noise canceling circuitry 520 and the gain of at least one of the transparency circuitry 510 or the sound source circuitry 515 based on a result of analyzing the second audio signal by the signal analyzer 530.

The gain/EQ controller 505 may identify whether the sound level (e.g., SPL) of the second audio signal exceeds the threshold level as a result of analyzing the second audio signal. When the sound level exceeds the threshold level, the gain/EQ controller 505 may adjust the gain of the noise canceling circuitry 520 and the gain of at least one of the transparency circuitry 510 or the sound source circuitry 515.

For example, when the sound level exceeds the threshold level during media playback, the gain/EQ controller 505 may control to increase the gain of the noise canceling circuitry 520 and decrease the gain of the transparency circuitry 510. Further, since the first audio signal output through the speaker 255 according to media playback includes the output of the sound source circuitry 515, the gain/EQ controller 505 may increase the gain of the noise canceling circuitry 520, decrease the gain of the transparency circuitry 510, and then finally adjust the sound level of the sound source circuitry 515. In this case, it is possible to meet the preference of a user who does not want to adjust the volume during media playback.

Since in the case of media, audio data (e.g., downloaded audio data or streaming audio data) stored in the memory 230 is reproduced, the first audio signal output through the speaker 255 according to media playback includes an output of the sound source circuitry 515, and thus the second audio signal obtained through the internal microphone 250c may also include the output of the sound source circuitry 515. Therefore, the signal analyzer 530 may also be able to analyze a signal from which the output of the sound source circuitry 515 included in the second audio signal, that is, a sound source (e.g., media) has been removed. To this end, the output of the sound source circuitry 515 may be removed (or filtered) from the second audio signal using an adaptive filter 545, and an output of the adaptive filter 545 may include the remaining signal except for the sound source (e.g., media). Accordingly, the signal analyzer 530 may analyze the second audio signal, which only includes the remaining signal other than the sound source. Whether to activate the adaptive filter 545 may be determined according to an on/off state of a signal remover 540.

As described above, the gain/EQ controller 505 may output a third audio signal obtained by mixing 525 the output of the gain-adjusted noise canceling circuitry 520 and the output of the gain-adjusted at least one of the transparency circuitry 510 or the sound source circuitry 515 through the speaker 255. As the audio signal is output through the gain-adjusted filter circuitry as described above, it is possible to prevent damage to the user's hearing while allowing the user to hear clear sounds.

The outputs of the noise canceling circuitry 520, the transparency circuitry 510, and/or the sound source circuitry 515 may all be generated as a single signal through summation as illustrated in FIG. 6 before being output to the speaker 255. Referring to 600a of FIG. 6, each source such as transparency 605, ANC 610, media 615, and/or a call 620 may be mixed 525 before a DAC 630 and output to the speaker 255. Referring to 600b of FIG. 6, when there are a plurality of DA Cs such as DAC1 635 and DAC2 640, the sources may be mixed 525a and 525b on a frequency band basis.

For example, on the assumption that a sound pressure audible to the user's ears is set to 80 dB or less, when an SPL detected as a result of analyzing the second audio signal is 90 dB, which exceeds the threshold level of 80 dB, the gain/EQ controller 505 may adjust the gain of the noise canceling circuitry 520 and the gain of at least one of the transparency circuitry 510 and/or the sound source circuitry 515 such that the SPL does not exceed the threshold level of 80 dB. When the situation in which the SPL is detected as 90 dB is due to an output of media playback and external noise, the gain/EQ controller 505 may decrease a volume level during media playback or increase the gain of the transparency circuitry 510 to decrease the external noise. In adjusting the gain of the filter circuitry, the gain/EQ controller 505 may identify priorities to determine filter circuitry to be increased in weight or filter circuitry whose gain is to be preferentially adjusted. For example, when the user sets the transparency function as a first priority and media volume control as a second priority, this setting information may indicate the user's intention to prioritize ambient sound over media playback sound. Accordingly, in a situation where the SPL is detected as 90 dB due to the introduction of external noise during media playback, the gain/EQ controller 505 may decrease the volume level during media playback to allow the ambient sound to be heard well, so that the SPL is 80 dB or lower. When the SPL does not reach 80 dB or lower despite the decrease of the volume level during media playback, the gain/EQ controller 505 may decrease the gain of the transparency circuitry 510 so that the SPL is 80 dB or lower.

In an embodiment, the gain/EQ controller 505 may identify the priority of the noise canceling circuitry 520, the transparency circuitry 510, and/or the sound source circuitry 515 based on the setting information, and may adjust the gain of the noise canceling circuitry 520 and the gain of at least one of the transparency circuitry 510 and/or the sound source circuitry 515 according to the identified priority. The setting information may include information related to a gain set by the user or a gain set by a manufacturer for at least one of the noise canceling circuitry, the transparency circuitry, and/or the sound source circuitry.

In an embodiment, the gain/EQ controller 505 may identify the priority of the noise canceling circuitry 520, the transparency circuitry 510, and/or the sound source circuitry 515 based on context information in addition to the setting information, and may adjust the gain of the noise canceling circuitry 520 and the gain of at least one of the transparency circuitry 510 and/or the sound source circuitry 515 according to the identified priority.

For example, when the user sets a siren sound as a first priority, sets media volume control as a second priority, sets the transparency function as a third priority, and sets the threshold level to 60 Db, this setting information may indicate the user's intention to prioritize the sound of an emergency situation over the sound of media playback. The gain/EQ controller 505 may identify whether the sound level of the second audio signal exceeds the threshold level. When the sound level of the second audio signal exceeds the threshold level, the gain/EQ controller 505 may adjust the gain of at least one of the transparency circuitry 510 and/or the sound source circuitry 515 according to the priority so that an SPL based on the sum of ambient sounds and the sum of media playback sounds becomes 60 dB or less. When a siren sound is detected as a result of analyzing the second audio signal by the signal analyzer 530, the gain/EQ controller 505 may adjust a gain so that the media volume level becomes 0 dB and may adjust the gain of the transparency circuitry 510 so that only the siren sound becomes 60 dB. The gain/EQ controller 505 may adjust the gain of the noise canceling circuitry 520, the transparency circuitry 510, and/or the sound source circuitry 515 using the type of an audio signal classified by the signal analyzer 530 as well as the context information.

According to an embodiment, the wearable electronic device 200 may include the at least one first microphone 250a and 250b disposed in the housing to face outside the user's ear, with the at least one second microphone 250c being disposed in the housing to face inside the ear, as well as the at least one speaker 255, the at least one processor 220, and the memory 230 storing instructions.

According to an embodiment, the instructions, when executed by the at least one processor, may cause the wearable electronic device to output a first audio signal through the at least one speaker.

According to an embodiment, the instructions, when executed by the at least one processor, may cause the wearable electronic device to obtain a second audio signal by mixing the first audio signal and a noise signal through the at least one second microphone.

According to an embodiment, the instructions, when executed by the at least one processor, may cause the wearable electronic device to adjust a gain of the noise canceling circuitry and a gain of at least one of the transparency circuitry or the sound source circuitry based on a result of the analysis.

According to an embodiment, the instructions, when executed by the at least one processor, may cause the wearable electronic device to output a third audio signal obtained by mixing an output of the gain-adjusted noise canceling circuitry and an output of the gain-adjusted at least one of the transparency circuitry or the sound source circuitry, through the at least one speaker.

According to an embodiment, the instructions, when executed by the at least one processor, may cause the wearable electronic device to identify whether a sound level of the second audio signal exceeds a threshold level, and adjust the gain of the active noise canceling circuitry and the gain of the at least one of the transparency circuitry and the sound source circuitry in case the sound level of the second audio signal exceeds the threshold level.

According to an embodiment, the instructions, when executed by the at least one processor, may cause the wearable electronic device to increase the gain of the active noise canceling circuitry and reduce the gain of the transparency circuitry in case the sound level of the second audio signal exceeds the threshold level.

According to an embodiment, the sound source circuitry includes at least one of a media source associated with media playback and a voice source associated with a call.

According to an embodiment, the instructions, when executed by the at least one processor, may cause the wearable electronic device to adjust a sound level of the sound source circuitry after increasing the gain of the active noise canceling circuitry and reducing the gain of the transparency circuitry in case the first audio signal includes an output of the sound source circuitry and the sound level of the second audio signal exceeds the threshold level.

According to an embodiment, the instructions, when executed by the at least one processor, may cause the wearable electronic device to remove the output of the sound source circuitry from the second audio signal in case the first audio signal includes an output of the sound source circuitry, and analyze the second audio signal from which the output of the sound source circuitry has been removed.

According to an embodiment, the instructions, when executed by the at least one processor, may cause the wearable electronic device to identify a priority of the active noise canceling circuitry, the transparency circuitry, and the sound source circuitry based on setting information.

According to an embodiment, the instructions, when executed by the at least one processor, may cause the wearable electronic device to adjust the gain of the active noise canceling circuitry and the gain of the at least one of the transparency circuitry and the sound source circuitry according to the identified priority based on the result of analyzing the second audio signal.

According to an embodiment, the wearable electronic device further comprises at least one sensor, wherein the instructions, when executed by the at least one processor, may cause the wearable electronic device to adjust the gain of the active noise canceling circuitry and the gain of the at least one of the transparency circuitry and the sound source circuitry based on context information output from the at least one sensor and the result of analyzing the second audio signal

According to an embodiment, the setting information includes information related to a gain set by the user or a gain set by a manufacturer for at least one of the active noise canceling circuitry, the transparency circuitry, and the sound source circuitry.

According to an embodiment, the wearable electronic device may include first and second microphones disposable to face outside and inside a user's ear, respectively, as well as a speaker, a processor, and memory storing instructions.

According to an embodiment, the instructions, when executed by the processor, may cause the wearable electronic device to output a first signal through the speaker.

According to an embodiment, the instructions, when executed by the at least one processor, may cause the wearable electronic device to obtain a second signal by mixing the first signal and a noise signal through the second microphone.

According to an embodiment, the instructions, when executed by the at least one processor, may cause the wearable electronic device to adjust a gain of active noise canceling circuitry and a gain of at least one of transparency circuitry and sound source circuitry based on a result of analyzing the second signal.

According to an embodiment, the instructions, when executed by the at least one processor, may cause the wearable electronic device to mix an output of the gain-adjusted active noise canceling circuitry and an output of the gain-adjusted at least one of the transparency circuitry and the sound source circuitry to obtain a third signal.

According to an embodiment, the instructions, when executed by the processor, may cause the wearable electronic device to output a third signal through the speaker.

According to an embodiment, the instructions, when executed by the processor, may cause the wearable electronic device to identify whether a sound level of the second signal exceeds a threshold level, and adjust the gain of the active noise canceling circuitry and the gain of the at least one of the transparency circuitry and the sound source circuitry in case the sound level of the second signal exceeds the threshold level.

According to an embodiment, the instructions, when executed by the processor, may cause the wearable electronic device to increase the gain of the active noise canceling circuitry and reduce the gain of the transparency circuitry in case the sound level of the second signal exceeds the threshold level.

According to an embodiment, the sound source circuitry includes at least one of a media source associated with media playback and a voice source associated with a call.

According to an embodiment, the instructions, when executed by the processor, may cause the wearable electronic device to adjust a sound level of the sound source circuitry after increasing the gain of the active noise canceling circuitry and reducing the gain of the transparency circuitry in case the first signal includes an output of the sound source circuitry and the sound level of the second signal exceeds the threshold level.

According to an embodiment, the instructions, when executed by the processor, may cause the wearable electronic device to remove the output of the sound source circuitry from the second signal in case the first signal includes an output of the sound source circuitry, and analyze the second signal from which the output of the sound source circuitry has been removed.

According to an embodiment, the instructions, when executed by the processor, may cause the wearable electronic device to identify a priority of the active noise canceling circuitry, the transparency circuitry, and the sound source circuitry based on setting information.

According to an embodiment, the instructions, when executed by the processor, may cause the wearable electronic device to adjust the gain of the active noise canceling circuitry and the gain of the at least one of the transparency circuitry and the sound source circuitry according to the identified priority based on the result of analyzing the second signal.

According to an embodiment, the wearable electronic device further comprises at least one sensor, wherein the instructions, when executed by the processor, may cause the wearable electronic device to adjust the gain of the active noise canceling circuitry and the gain of the at least one of the transparency circuitry and the sound source circuitry based on context information output from the at least one sensor and the result of analyzing the second signal.

According to an embodiment, the setting information includes information related to a gain set by the user or a gain set by a manufacturer for at least one of the active noise canceling circuitry, the transparency circuitry, and the sound source circuitry.

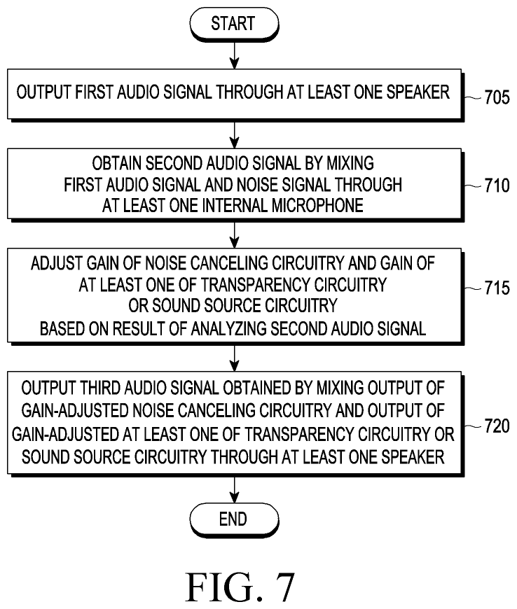

FIG. 7 is a flowchart illustrating an operation of controlling the output of an audio signal in a wearable electronic device according to an embodiment. Referring to FIG. 7, the operation method may include operations 705 to 720. Each operation of the operating method of FIG. 7 may be performed by the wearable electronic device (e.g., the wearable electronic device 200 of FIGS. 2A and 2B) or at least one processor (e.g., the processor 220 of FIG. 2B or the processor (or control circuit) 220 of FIG. 5) of the wearable electronic device. In an embodiment, at least one of operations 705 to 720 may be omitted, the order of some operations may be changed, or another operation may be added.

According to an embodiment, in operation 705, the wearable electronic device 200 may output a first audio signal through the at least one speaker 255.

According to an embodiment, in operation 710, the wearable electronic device 200 may obtain a second audio signal by mixing the first audio signal and a noise signal through the at least one second microphone 250c among the at least one first microphone 250a and 250b (e.g., an external microphone) disposed in the housing 322 to face outside the user's ear and the at least one second microphone 250c (e.g., an internal microphone) disposed in the housing to face inside the ear, when the wearable electronic device 200 is worn by the user.

According to an embodiment, in operation 715, the wearable electronic device 200 may adjust a gain of the noise canceling circuitry 520 and a gain of at least one of the transparency circuitry 510 or the sound source circuitry 515 based on a result of analyzing the second audio signal.

According to an embodiment, the sound source circuitry 515 may include a media source associated with media playback and/or a voice source associated with a call.

According to an embodiment, when an output of the sound source circuit is included in the first audio signal, the wearable electronic device 200 may remove the output of the sound source circuitry 515 from the second audio signal. The wearable electronic device 200 may analyze the second audio signal from which the output of the sound source circuitry 515 has been removed.

According to an embodiment, the wearable electronic device 200 may identify whether a sound level of the second audio signal exceeds a threshold level. When the sound level of the second audio signal exceeds the threshold level, the wearable electronic device 200 may adjust the gain of the noise canceling circuitry 520 and the gain of at least one of the transparency circuitry 510 or the sound source circuitry 515.

According to an embodiment, when the sound level of the second audio signal exceeds the threshold level, the wearable electronic device 200 may increase the gain of the noise canceling circuitry 520 and decrease the gain of the transparency circuitry 510.

According to an embodiment, when the output of the sound source circuitry 515 is included in the first audio signal and the sound level of the second audio signal exceeds the threshold level, the wearable electronic device 200 may increase the gain of the noise canceling circuitry 520, decrease the gain of the transparency circuitry 510, and then adjust the sound level of the sound source circuitry 515.

According to an embodiment, in operation 720, the wearable electronic device 200 may output a third audio signal obtained by mixing an output of the gain-adjusted noise canceling circuitry 520 with an output of the gain-adjusted at least one of the transparency circuitry 510 and/or the sound source circuitry 515, through the at least one speaker 255.

According to an embodiment, the wearable electronic device 200 may identify a priority of the noise canceling circuitry 520, the transparency circuitry 510, and/or the sound source circuitry 515 based on setting information. The setting information may include information related to a gain set by the user or a gain set by a manufacturer for at least one of the noise canceling circuitry 520, the transparency circuitry 510, and/or the sound source circuitry 515.

According to an embodiment, the wearable electronic device 200 may adjust the gain of the noise canceling circuitry 520 and the gain of the at least one of the transparency circuitry 510 or the sound source circuitry 515 according to the identified priority, based on the result of analyzing the second audio signal.

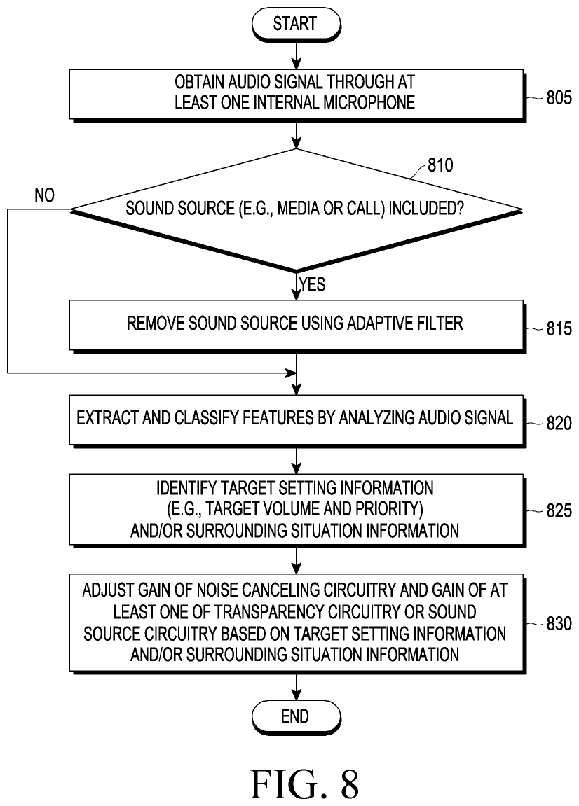

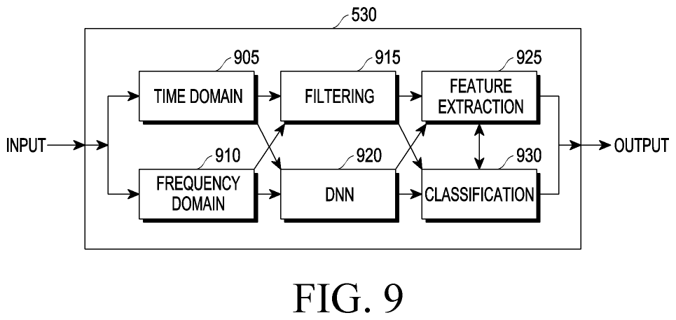

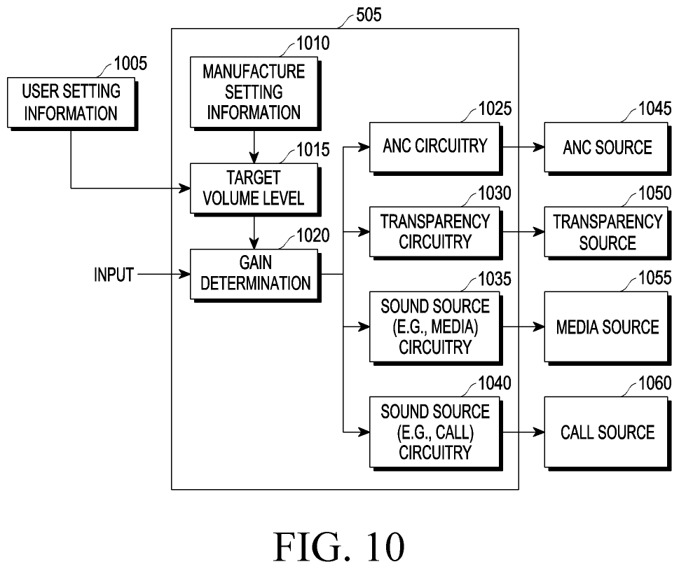

According to an embodiment, the wearable electronic device 200 may adjust the gain of the noise canceling circuitry 520 and the gain of the at least one of the transparency circuitry 510 or the sound source circuitry 515, based on the result of analyzing the second audio signal and context information output from at least one sensor. FIG. 8 is a detailed flowchart illustrating an operation of controlling the output of an audio signal including a sound source in a wearable electronic device according to an embodiment. Referring to FIG. 8, the operation method may include operations 805 to 830. Each operation of the operating method of FIG. 8 may be performed by the wearable electronic device (e.g., the wearable electronic device 200 of FIGS. 2A and 2B) or at least one processor (e.g., the processor 220 of FIG. 2B or the processor (or control circuit) 220 of FIG. 5) of the wearable electronic device. In an embodiment, at least one of operations 805 to 830 may be omitted, the order of some operations may be changed, or another operation may be added. In order to help understanding of the description of FIG. 8, the description will be made with reference to FIGS. 9 and 10. FIG. 9 is a diagram illustrating an operation of analyzing an audio signal obtained through a microphone according to an embodiment, and FIG. 10 is a diagram illustrating a method of adjusting a gain based on setting information according to an embodiment.

Referring to FIG. 8, the wearable electronic device 200 may be outputting an audio signal through the speaker 255.

In an embodiment, in operation 805, the wearable electronic device 200 may obtain an audio signal through at least one internal microphone (e.g., microphone 3 250c of FIGS. 3 and 4). The audio signal obtained through the internal microphone may correspond to the output of the speaker 255 and include a noise signal in addition to the output of the speaker 255. For example, not only the audio signal output from the speaker 255, but also a noise signal such as a sound penetrating the wearable electronic device 200, an external noise entering through an ear gap, and a voice entering through a Eustachian tube may be received through the internal microphone.

In operation 810, the wearable electronic device 200 may identify whether a sound source (e.g., media or a call) is included. For example, during outputting of a sound source (e.g., media playback), an audio signal corresponding to the sound source may also be output through the speaker 255, and thus a signal output through the speaker 255 may include the sound source.

When the sound source is included, the wearable electronic device 200 may remove the sound source through the adaptive filter 545 in operation 815. On the contrary, when the sound source is not included, the wearable electronic device 200 may extract and classify features by analyzing the audio signal obtained through the internal microphone in operation 820.

Referring to FIG. 9, the wearable electronic device 200 (e.g., the signal analyzer 530) may convert the audio signal received through the internal microphone into a time domain 905 or a frequency domain 910. The wearable electronic device 200 may perform filtering 915 using various filters in the time domain 905 or the frequency domain 910. For example, the filters may be implemented in a form in which infinite impulse response (IIR) or finite impulse response (FIR)-based high pass filter (HPF), low pass filter (LPF), or band pass filter (BPF) is integrated.

The wearable electronic device 200 may extract 925 one or more features from the audio signal in the time domain 905 or the frequency domain 910. In addition, the wearable electronic device 200 may classify 930 features in an embedding space or the type of the audio signal into a corresponding sound, using a DNN method 920. For example, the wearable electronic device 200 may classify sounds such as a vehicle sound, a siren sound, and a male, female, or child voice by analyzing the audio signal.

In operation 825, the wearable electronic device 200 may identify target setting information (e.g., a target volume (or threshold level) and a priority) and/or surrounding situation information.

In operation 830, the wearable electronic device 200 may adjust a gain of the noise canceling circuitry 520 and a gain of at least one of the transparency circuitry 510 or the sound source circuitry 515 based on the target setting information (e.g., the target volume and the priority) and/or the surrounding situation information.

Referring to FIG. 10, the wearable electronic device 200 may determine a target volume level 1015 (or threshold level) based on setting information (e.g., user setting information 1005 or manufacturer setting information 1010). The wearable electronic device 200 may compare an SPL among features of an audio signal obtained through an internal microphone with the threshold level. When the SPL exceeds the threshold level as a result of analyzing the audio signal obtained through the internal microphone, the wearable electronic device 200 may determine 1020 a gain of filter circuitry (e.g., ANC circuitry 1025, transparency circuitry 1030, sound source (e.g., media) circuitry 1035, or sound source (e.g., call) circuitry 1040 so that the SPL does not exceed the threshold level.

In an embodiment, for each of the ANC circuitry 1025, the transparency circuitry 1030, the sound source (e.g., media) circuitry 1035, or the sound source (e.g., call) circuitry 1040, how much to adjust a gain and which filter to be considered preferentially may be determined based on the setting information (e.g., the user setting information 1005 or the manufacturer setting information 1010). Accordingly, the wearable electronic device 200 may output sources such as an ANC source 1045, a transparency source 1050, a media source 1055, or a call source 1060 from each of the gain-adjusted ANC circuitry 1025, transparency circuitry 1030, sound source (e.g., media) circuitry 1035, or sound source (e.g., call) circuitry 1040, and all of these sources may be output to the speaker 255 through summation or mixing.

According to an embodiment, the output of an audio signal may be controlled by adjusting the gain of filter circuitry in response to the features of an audio signal output toward the user's inner ear, regardless of whether a function such as the ANC function or the transparency function is activated/deactivated. In this way, the wearable electronic device 200 may adaptively control the output of an audio signal in response to various surrounding environments and/or wearing states, thereby having the effect of adjusting the intensity of a sound heard by the user and thus protecting hearing.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (A SIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, in computer-readable storage medium storing at least one instruction, the at least one instruction may cause the wearable electronic device 200 to perform at least one operation, when executed by the at least one processor 220 of the wearable electronic device 200. The at least one operation may include outputting a first audio signal through the at least one speaker 255.

According to an embodiment, the at least one operation may include obtaining a second audio signal by mixing the first audio signal and a noise signal through the at least one second microphone 250c among the at least one first microphone 250a and 250b disposed in the housing to face outside a user's ear and the at least one second microphone disposed in the housing to face inside the user's ear, when the wearable electronic device is worn by the user.

According to an embodiment, the at least one operation may include, based on a result of analyzing the second audio signal, adjusting a gain of the active noise canceling circuitry 520 and a gain of at least one of the transparency circuitry 510 or the sound source circuitry 515.

According to an embodiment, the at least one operation may include outputting, through the at least one speaker, a third audio signal obtained by mixing an output of the gain-adjusted active noise canceling circuitry and an output of the gain-adjusted at least one of the transparency circuitry or the sound source circuitry.

What is claimed is:

1. A wearable electronic device comprising:
first and second microphones disposable to face outside and inside a user's ear, respectively;
a speaker;
a processor; and
memory storing instructions that, when executed by the processor, cause the wearable electronic device to:
output a first signal through the speaker,
obtain a second signal by mixing the first signal and a noise signal through the second microphone,
adjust a gain of active noise canceling circuitry and a gain of at least one of transparency circuitry and sound source circuitry based on a result of analyzing the second signal,
mix an output of the gain-adjusted active noise canceling circuitry and an output of the gain-adjusted at least one of the transparency circuitry and the sound source circuitry to obtain a third signal, and
output the third signal through the speaker.

2. The electronic device of claim 1, wherein the instructions, when executed by the processor, cause the wearable electronic device to:
identify whether a sound level of the second signal exceeds a threshold level, and
adjust the gain of the active noise canceling circuitry and the gain of the at least one of the transparency circuitry and the sound source circuitry in case the sound level of the second signal exceeds the threshold level.

3. The electronic device of claim 2, wherein the instructions, when executed by the processor, cause the wearable electronic device to:
increase the gain of the active noise canceling circuitry and reduce the gain of the transparency circuitry in case the sound level of the second signal exceeds the threshold level.

4. The electronic device of claim 3, wherein the sound source circuitry includes at least one of a media source associated with media playback and a voice source associated with a call.

5. The electronic device of claim 3, wherein the instructions, when executed by the processor, cause the wearable electronic device to:
adjust a sound level of the sound source circuitry after increasing the gain of the active noise canceling circuitry and reducing the gain of the transparency circuitry in case the first signal includes an output of the sound source circuitry and the sound level of the second signal exceeds the threshold level.

6. The electronic device of claim 1, wherein the instructions, when executed by processor, cause the wearable electronic device to:
remove the output of the sound source circuitry from the second signal in case the first signal includes an output of the sound source circuitry, and
analyze the second signal from which the output of the sound source circuitry has been removed.

7. The electronic device of claim 1, wherein the instructions, when executed by the processor, cause the wearable electronic device to identify a priority of the active noise canceling circuitry, the transparency circuitry, and the sound source circuitry based on setting information.

8. The electronic device of claim 7, wherein the instructions, when executed by the processor, cause the wearable electronic device to:
adjust the gain of the active noise canceling circuitry and the gain of the at least one of the transparency circuitry and the sound source circuitry according to the identified priority based on the result of analyzing the second signal.

9. The electronic device of claim 7, further comprising at least one sensor,
wherein the instructions, when executed by the processor, cause the wearable electronic device to adjust the gain of the active noise canceling circuitry and the gain of the at least one of the transparency circuitry and the sound source circuitry based on context information output from the at least one sensor and the result of analyzing the second signal.

10. The electronic device of claim 9, wherein the setting information includes information related to a gain set by the user or a gain set by a manufacturer for at least one of the active noise canceling circuitry, the transparency circuitry, and the sound source circuitry.

11. A method of controlling an output of an audio signal in a wearable electronic device, comprising:
outputting a first audio signal through at least one speaker;
obtaining a second audio signal by mixing the first audio signal and a noise signal through at least one second microphone among at least one first microphone disposed in a housing to face outside a user's ear and the at least one second microphone disposed in the housing to face inside the user's ear, when the wearable electronic device is worn by the user;
adjusting a gain of active noise canceling circuitry and a gain of at least one of transparency circuitry and sound source circuitry based on a result of analyzing the second audio signal; and
outputting, through the at least one speaker, a third audio signal obtained by mixing an output of the gain-adjusted active noise canceling circuitry and an output of the gain-adjusted at least one of the transparency circuitry and the sound source circuitry.

12. The method of claim 11, wherein the adjusting of the gain of the active noise canceling circuitry and the gain of the at least one of the transparency circuitry and the sound source circuitry includes:
identifying whether a sound level of the second audio signal exceeds a threshold level, and
adjusting the gain of the active noise canceling circuitry and the gain of the at least one of the transparency circuitry and the sound source circuitry in case the sound level of the second audio signal exceeds the threshold level.

13. The method of claim 12, wherein the adjusting of the gain of the at least one of transparency circuitry and the sound source circuitry includes increasing the gain of the active noise canceling circuitry and reducing the gain of the transparency circuitry in case the sound level of the second audio signal exceeds the threshold level.

14. The method of claim 13, wherein the sound source circuitry includes at least one of a media source associated with media playback and a voice source associated with a call.

15. The method of claim 13, wherein the adjusting of the gain of the at least one of transparency circuitry or the sound source circuitry includes adjusting a sound level of the sound source circuitry after increasing the gain of the active noise canceling circuitry and reducing the gain of the transparency circuitry in case the first audio signal includes an output of the sound source circuitry and the sound level of the second audio signal exceeds the threshold level.

16. The method of claim 11, comprising:
removing the output of the sound source circuitry from the second audio signal in case the first audio signal includes an output of the sound source circuitry; and
analyzing the second audio signal from which the output of the sound source circuitry has been removed.

17. The method of claim 11, further comprising identifying a priority of the active noise canceling circuitry, the transparency circuitry, and the sound source circuitry based on setting information.

18. The method of claim 17, wherein the adjusting of the gain of the at least one of transparency circuitry or the sound source circuitry includes adjusting the gain of the active noise canceling circuitry and the gain of the at least one of the transparency circuitry and the sound source circuitry according to the identified priority based on the result of analyzing the second audio signal.

19. The method of claim 17, wherein the adjusting of the gain of the at least one of transparency circuitry and the sound source circuitry includes adjusting the gain of the active noise canceling circuitry and the gain of the at least one of the transparency circuitry and the sound source circuitry based on context information output from at least one sensor and the result of analyzing the second audio signal.

20. A computer-readable storage medium storing at least one instruction which, when executed by at least one processor of a wearable electronic device, causes the wearable electronic device to perform at least one operation comprising:
outputting a first audio signal through at least one speaker;
obtaining a second audio signal by mixing the first audio signal and a noise signal through at least one second microphone among at least one first microphone disposed in a housing to face outside a user's ear and the at least one second microphone disposed in the housing to face inside the user's ear, when the wearable electronic device is worn by the user;
adjusting a gain of active noise canceling circuitry and a gain of at least one of transparency circuitry and sound source circuitry based on a result of analyzing the second audio signal; and
outputting, through the at least one speaker, a third audio signal obtained by mixing an output of the gain-adjusted active noise canceling circuitry and an output of the gain-adjusted at least one of the transparency circuitry or the sound source circuitry.
